(19) United States
(12) Patent Application Publication
(10) Pub. No.: US 2017/0168705 A1
(43) Pub. Date: Jun. 15, 2017

(54) Method and electronic device for adjusting video progress

(71) Applicants: Le Holdings (Beijing) Co., Ltd., Beijing (CN); Le Shi Internet Information & Technology Corp., Beijing, Beijing (CN)

(72) Inventor: Zhennian Li, Chao Yang District (CN)

(21) Appl. No.: 15/241,363

(22) Filed: Aug. 19, 2016

Related U.S. Application Data
(63) Continuation of application No. PCT/CN2016/089563, filed on Jul. 10, 2016.

(30) Foreign Application Priority Data
Dec. 14, 2015 (CN) 201510927642.0

(51) Int. Cl. G06F 3/0488; G06F 3/041; G06F 3/0484

(52) U.S. Cl. CPC G06F 3/04883; G06F 3/0484; G06F 3/0414; H04W 88/02

(57) ABSTRACT

Embodiments of the present application provide a method and electronic device for adjusting video progress, and a mobile terminal device. The method includes: acquiring a progress adjusting operation above a progress bar, wherein in a video play window, the progress adjusting operation corresponds to a start contact; using any two points on the progress bar as endpoints, and displaying a trajectory according to the endpoints and the start contact; acquiring, in the video play window, a slide operation corresponding to the progress adjusting operation, wherein the trajectory changes with the slide operation; acquiring, in the video play window, a release operation corresponding to the progress adjusting operation, wherein in the video play window, the release operation corresponds to an end contact; and adjusting video play progress according a distance between a point that is a mapping point of the end contact and is on the progress bar and a current play progress point. By using the technical solutions of the present application, a user may conveniently and quickly adjust video play progress, thereby improving use experience of the user.

### CROSS-REFERENCE TO RELATED APPLICATIONS

This application is a continuation of PCT application No. PCT/CN2016/089563 submitted on Jul. 10, 2016, which is based upon and claims priority to Chinese Patent Application No. 201510927642.0, filed before Chinese Patent Office on Dec. 14, 2015 and entitled “METHOD AND APPARATUS FOR ADJUSTING VIDEO PROGRESS AND MOBILE TERMINAL DEVICE,” the entire contents of which are incorporated herein by reference.

### TECHNICAL FIELD

This patent application relates to the field of video play, and more particularly, to a method and electronic device for adjusting video progress.

### BACKGROUND

With the constant development of network technologies and terminal devices, a user group that watch videos by using a mobile terminal device (including a smart mobile phone, a table computer, and the like) has been enlarged day by day. When a user watches a video by using a mobile terminal device, if the user wants to know a subsequent video story or review a previous video story, the user may drag a progress bar in a video play window to adjust video play progress, so as to jump to corresponding video progress to watch the video.

When dragging the progress bar, the user needs to first touch the video play window to display the progress bar hidden on a lower end of the video play window. To reduce effects on video watch of the user, the progress bar is generally designed to be fine, and the user needs to carefully control a dragging manner to effectively drag the progress bar. In addition, when the user drags the progress bar to adjust video progress, it is difficult to control a dragging distance of the progress bar, and a big difference between video adjusting progress and adjusting progress expected by the user usually occurs; for example, the user hopes to accelerate the video by one minute, while after the user drags the progress bar, the video progress may be accelerated by three minutes.

In general, the manner of adjusting the video play progress by dragging the progress bar has poor flexibility, and low efficiency of adjusting video progress, thereby causing poor use experience of the user.

### SUMMARY

An objective of an embodiment of the present disclosure is to provide a method and electronic device for adjusting video progress, such that a user may conveniently and quickly adjust video progress, thereby improving use experience of the user.

According to an aspect of the present invention, some embodiments of the present invention provide a method for adjusting video progress, wherein a video play window includes a progress bar. The method includes: acquiring a progress adjusting operation above the progress bar, wherein in the video play window, the progress adjusting operation corresponds to a start contact; using any two points on the progress bar as endpoints, and displaying a trajectory according to the endpoints and the start contact; acquiring, in the video play window, a slide operation corresponding to the progress adjusting operation, wherein the trajectory changes with the slide operation; acquiring, in the video play window, a release operation corresponding to the progress adjusting operation, wherein in the video play window, the release operation corresponds to an end contact; and adjusting video play progress according a distance between a point that is a mapping point of the end contact and is on the progress bar and a current play progress point.

According to another aspect of the disclosure, an embodiment of the disclosure further provides a non-volatile computer storage medium, which stores computer executable instructions, where the computer executable instructions are used to execute any of the foregoing methods for adjusting video progress of the disclosure.

According to another aspect of the disclosure, an embodiment of the disclosure further provides an electronic device, including: at least one processor; and a memory, where the memory stores a program that can be executed by the at least one processor, and the instructions are executed by the at least one processor, so that the at least one processor can execute any of the foregoing methods for adjusting video progress of the disclosure.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart illustrating a method for adjusting video progress according to an embodiment of the present disclosure;

FIG. 2 is a flowchart illustrating a method for acquiring a progress adjusting operation of a method for adjusting video progress according to an embodiment of the present disclosure;

FIG. 3 is a schematic structural diagram illustrating an apparatus for adjusting video progress according to an embodiment of the present disclosure; and

FIG. 4 is a schematic structural diagram illustrating a first acquiring unit of an apparatus for adjusting video progress according to an embodiment of the present disclosure;

FIG. 5 is a schematic structural diagram of hardware of an electronic device for executing a method for adjusting video progress according an embodiment of the present disclosure.

### DETAILED DESCRIPTION

A basic concept of some embodiments of the present disclosure is to provide a method and electronic device for adjusting video progress. In a video play process, according to a progress adjusting operation of a user in a window play window, correspondingly displaying a trajectory that changes with a slide operation corresponding to the progress adjusting operation provides video play of corresponding progress for a user, such that the user may conveniently and quickly adjust video play progress, thereby improving use experience of the user.

The method and electronic device for adjusting video progress according to exemplary embodiments of the present disclosure are described hereinafter in detail with reference to the accompanying drawings.

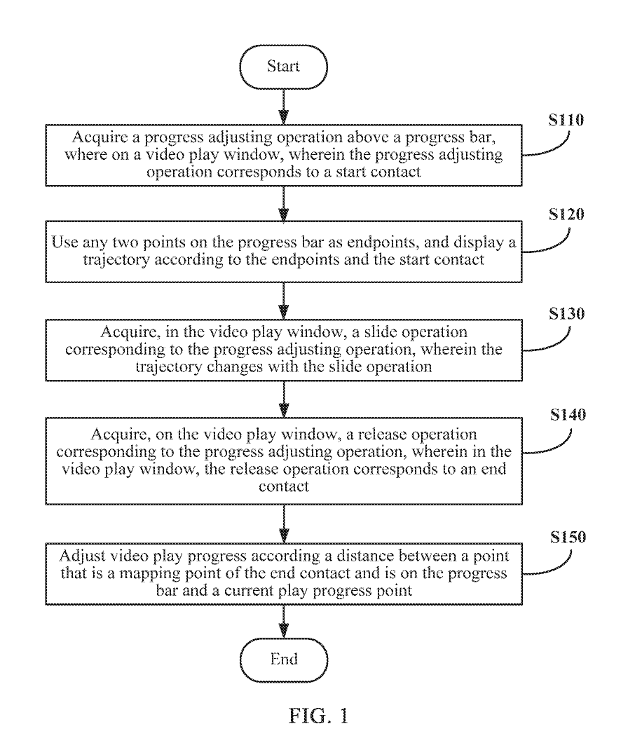

FIG. 1 is a flowchart illustrating a method for adjusting video progress according to an embodiment of the present disclosure. The method may be used to adjust video play progress in a video play process, so as to provide video play of corresponding progress for a user. An execution body of the method may be, for example, an apparatus for adjusting video progress as illustrated in FIG. 3, or may include a mobile terminal device including the apparatus for adjusting video progress as illustrated in FIG. 3, for example, a smart phone, or a tablet computer.

With reference to FIG. 1, the method for adjusting video progress of this embodiment of the present disclosure includes the following steps.

In step S110, a progress adjusting operation above a progress bar is acquired, wherein in a video play window, the progress adjusting operation corresponds to a start contact.

In this embodiment, when a user watches a video by using a mobile terminal device, a current video play window includes a progress bar that displays the video play progress. If the user wants to know a subsequent story, or review a previous story, the user may perform a progress adjusting operation in the video play window, and perform a slide operation after the operation adjusting operation; the mobile terminal device detects the progress adjusting operation and the slide operation, and adjusts the video play progress according to the slide operation, and provides video play of corresponding progress for the user. The progress adjusting operation may be performed at any location above the progress bar in the video play window; as compared with performing a dragging action on the progress bar with a relatively small shape, the user may perform the progress adjusting operation more conveniently.

Specifically, a pressure sensor is provided in a display component (including a touch screen) of the mobile terminal device, wherein the pressure sensor may detect the progress adjusting operation performed above the progress bar by the user. When the user performs the progress adjusting operation, the pressure sensor may detect a touch point of the user on the mobile terminal device, wherein the touch point is a start contact in the video play window.

In step S120, any two points on the progress bar are used as endpoints, and a trajectory is displayed according to the endpoints and the start contact.

After the start contact in the video play window is acquired, any two points on the progress bar may be selected as endpoints; the start contact and the two endpoints are connected to form a trajectory so as to display a specific location of the start contact in the video play window, such that the user may observe a location of the start contact relative to the progress bar.

In step S130, a slide operation corresponding to the progress adjusting operation is acquired in the video play window, wherein the trajectory changes with the slide operation.

After performing the progress adjusting operation in the video play window, the user may adjust the video play progress by means of the slide operation. The touch point of the user on the mobile terminal device moves with the slide operation; the touch point, as an alternative of the start contact, forms the trajectory with the foregoing two endpoints, and then the trajectory changes with the slide operation, and displays a change trajectory of the slide operation. The user may observe a slide distance corresponding to the slide operation by observing changes of the trajectory, and determine whether the slide distance corresponds to video progress expected by the user. When the slide distance does not reach the video progress expected by the user, the user may continue to perform the slide operation, so as to adjust the video play progress to the expected video progress.

In step S140, a release operation corresponding to the progress adjusting operation is acquired in the video play window, wherein in the video play window, wherein the release operation corresponds to an end contact.

If the slide distance of the slide operation reaches the video progress expected by the user, the user may stop the slide operation, and perform a release operation on the progress adjusting operation. When the user performs the release operation, the mobile terminal device may acquire, in the video play window, an end contact corresponding to the release operation; when the end contact corresponds to the video progress expected by the user, the mobile terminal device may adjust the video play progress according to the end contact.

In step S150, video play progress is adjusted according a distance between a point that is a mapping point of the end contact and is on the progress bar and a current play progress point.

After the mobile terminal device acquires the end contact, the mobile terminal device, or a video application program in the mobile terminal device acquires a point that is a mapping point of the end contact and is on the progress bar, acquires a distance between the point and a current play progress point, and adjusts video progress by a corresponding distance according to the distance, such that the user may watch the video at corresponding video progress.

According to the method for adjusting video progress in this embodiment of the present disclosure, by acquiring, in a video play window, a progress adjusting operation and a slide operation of a user, and correspondingly displaying the slide operation of the user in a form of a trajectory, the user may conveniently and quickly adjust video play progress, thereby improving use experience of the user.

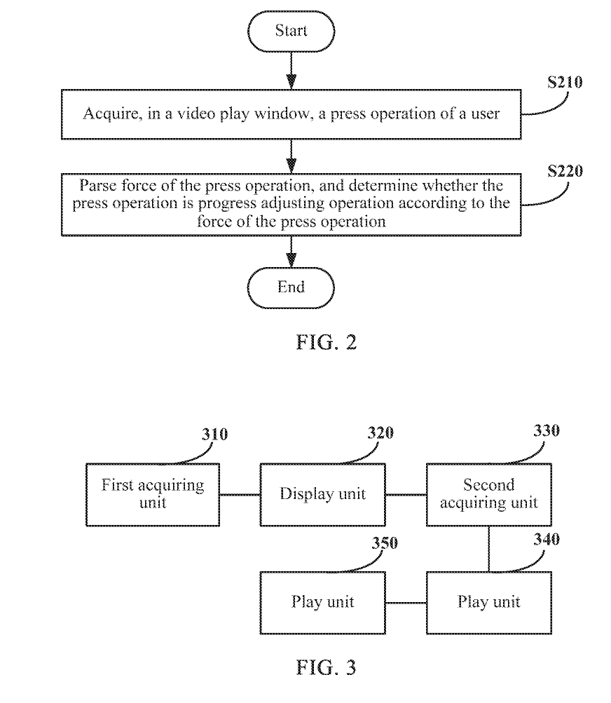

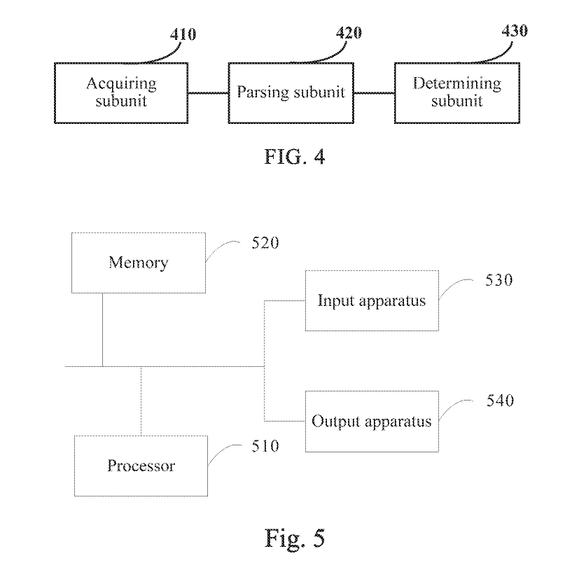

FIG. 2 is a flowchart illustrating a method for acquiring a progress adjusting operation of a method for adjusting video progress according to an embodiment of the present disclosure. The method may be considered as steps to be executed before the method for adjusting video progress illustrated in FIG. 1, and an execution body thereof may be an apparatus illustrated in FIG. 4, or a mobile terminal device including the apparatus illustrated in FIG. 4.

With reference to FIG. 2, the method for acquiring the progress adjusting operation includes the following steps.

In step S210, a press operation of a user is acquired in a video play window.

When a user performs the progress adjusting operation in a video play window, the user needs to touch a touch screen of the mobile terminal device, and perform a press operation; a pressure sensor in the mobile terminal device may detect a press point and press pressure corresponding to the press operation, so as to acquire the foregoing start contact and force of the press operation.

In step S220, force of the press operation is parsed, and it is determined whether the press operation is progress adjusting operation according to the force of the press operation.

After the force of the press operation is acquired, a specific force value of the press operation may be parsed, so as to determine whether a type of the press operation is the progress adjusting operation. Specifically, the force of the press operation may be parsed by using an existing touch technology of a mobile intelligent terminal device, and the force of the press operation is compared with a preset press pressure threshold, so as to determine whether the press operation corresponds to a jump request or a preview request. For example, if the force value of the press operation is less than the preset press pressure threshold, then the press operation does not correspond to the progress adjusting operation; if the force value of the press operation is greater than or equal to the preset press pressure threshold, then the press operation corresponds to the progress adjusting operation.

In an example, the press operation is light tap, light press, or heavy press. The touch technology of a mobile intelligent terminal may be used to acquire the progress adjusting operation of the user by the press operation of the user in the video play window. Specific description may be provided by using a touch manner of a smart mobile phone in the prior art as an example. Using a touch technology 3DTouch developed by Apple Inc as an example, a function of a dimension: heavy press (Pop) is added based on the original Force Touch light tap, and light press (PeeK), and a screen of a featured product thereof iPhone 6s has three layers of dimensions: light tap, light press, and heavy press.

According to the present solution, based on the touch manner of the three layers of dimensions: light tap, light press, and heavy press of the 3DTouch, any dimension therein may be used as the progress adjusting operation of the user in the video play window; whether the press operation is light tap, light press, or heavy press may be determined by detecting the force of the press operation, so as to determine whether the press operation corresponds to the progress adjusting operation. For example, the dimension: heavy press is set to correspond to the progress adjusting operation; when the user heavily presses any location in the video play window, the video play progress may be adjusted by a slide operation.

In this embodiment, the mobile terminal device may effectively acquire the progress adjusting operation of the user in the video play window by using the foregoing method for acquiring the progress adjusting operation, and the mobile terminal device executes the method for adjusting video progress as illustrated in FIG. 1, and displays a trajectory that changes with the slide operation, such that the user may acquire video play of corresponding progress according to the changes of the trajectory.

In an example, the trajectory is a smooth curve or a broken line. Designing the trajectory as a smooth curve or a broken line enables a connection between touch points of the user in the video play window and endpoints on the progress bar to be more natural, thereby making the trajectory more ornamental, and increasing operability of the slide operation performed by the user, such that the user has high use experience when observing the changes of the trajectory. The smooth curve is preferably a parabola or an arc.

It should be noted that the touch points of the user in the video play window are connected to the endpoints on the progress bar so as to form the trajectory; the touch points (including a start contact and an end contact) and a slide trajectory that corresponds to the slide operation formed by changes of the touch points may be at any locations in the video play window according to operating habits of the user on the mobile terminal device. There are multiple forms of location relationships between the start contact and the end contact. For example, the start contact and the end contact are between the two endpoints; the start contact or the end contact is one of the two endpoints; or the start contact and the end contact are before or after a current play progress point.

The method for adjusting video progress of this embodiment of the present disclosure further shows, based on the method for adjusting video progress of the embodiment illustrated in FIG. 1, the manner for acquiring a progress adjusting operation, and specific forms of a trajectory that displays a slide operation of a user. The method for adjusting video progress may provide video play of corresponding progress for the user, and enables the user to have high use experience when the user adjusts video progress.

FIG. 3 is a schematic structural diagram illustrating an apparatus for adjusting video progress according to an exemplary embodiment of the present disclosure. The apparatus may be used to execute the method for adjusting video progress of the embodiment illustrated in FIG. 1.

With reference to FIG. 3, the interaction apparatus during multimedia play includes a first acquiring unit 310, a display unit 320, a second acquiring unit 330, a releasing unit 340, and an adjusting unit 350.

The first acquiring unit 310 is configured to acquire a progress adjusting operation above a progress bar, wherein in a video play window, wherein the progress adjusting operation corresponds to a start contact.

The display unit 320 is configured to use any two points on the progress bar as endpoints, and display a trajectory according to the endpoints and the start contact corresponding to the progress adjusting operation acquired by the first acquiring unit.

The second acquiring unit 330 is configured to acquire, in the video play window, a slide operation corresponding to the progress adjusting operation acquired by the first acquiring unit, wherein the trajectory changes with the slide operation.

The releasing unit 340 is configured to acquire, in the video play window, a release operation of the progress adjusting operation acquired by the first acquiring unit, wherein in the video play window, the release operation corresponds to an end contact.

The adjusting unit 350 is configured to adjust video play progress according a distance between a point that is a mapping point of the end contact corresponding to the release operation acquired by the releasing unit and is on the progress bar and a current play progress point.

In an embodiment, with reference to FIG. 4, the first acquiring unit 310 includes an acquiring subunit 410, a parsing subunit 420, and a determining subunit 430. The acquiring subunit 410 is configured to acquire, in the video play window, a press operation of a user; the parsing subunit 420 is configured to parse force of the press operation acquired by the acquiring subunit; and the determining subunit 430 is configured to determine whether the press operation is the progress adjusting operation according to the force, which is parsed by the parsing subunit, of the press operation.

In an embodiment, the trajectory is a smooth curve or a broken line, and when the trajectory is the smooth curve, the smooth curve is a parabola or an arc; and/or, the start contact and/or the end contact are/is between the endpoints, or, the start contact and/or the end contact are/is one of the endpoints; or the start contact and/or the end contact are/is before or after the current play progress point.

According to another aspect of the present disclosure, an embodiment of the present disclosure further provides a mobile terminal device. The mobile terminal device includes the apparatus for adjusting video progress, and may be used to perform the method for adjusting video play progress of the embodiment illustrated in FIG. 1.

According to the adjusting apparatus for adjusting video progress and the mobile terminal device in the embodiments of the present disclosure, in a video play process, by acquiring, in a video play window, a progress adjusting operation and a slide operation of a user, and correspondingly displaying a trajectory corresponding to the slide operation, the user may conveniently adjust video play progress, thereby improving use experience of the user.

An embodiment of the disclosure provides a non-volatile computer storage medium, which stores computer executable instructions, where the computer executable instructions can execute the method for adjusting video progress of any of the foregoing method embodiments of the disclosure.

FIG. 5 is a schematic structural diagram of hardware of an electronic device for executing a method for adjusting video progress provided by an embodiment of the disclosure. As shown in FIG. 5, the device includes:

one or more processors 510 and a memory 520, with one processor 510 as an example in FIG. 5.

A device for executing the method for adjusting video progress may further include: an input apparatus 530 and an output apparatus 540.

The processor 510, the memory 520, the input apparatus 530, and the output apparatus 540 can be connected by means of a bus or in other manners, with a connection by means of a bus as an example in FIG. 5.

As a non-volatile computer readable storage medium, the memory 520 can be used to store non-volatile software programs, non-volatile computer executable programs and modules, for example, program instructions/module corresponding to the method for adjusting video progress in the embodiments of the disclosure (for example, a first acquiring unit 310, a display unit 320, a second acquiring unit 330, a releasing unit 340, and an adjusting unit 350 shown in FIG. 3). The processor 510 executes various functional applications and data processing of the server, that is, implements the method for adjusting video progress of the foregoing method embodiments, by running the non-volatile software programs, instructions, and modules stored in the memory 520.

The memory 520 may include a program storage area and a data storage area, where the program storage area may store an operating system and at least one application needed by function; the data storage area may store data created according to use of an apparatus for adjusting video progress, and the like. In addition, the memory 520 may include a high-speed random access memory, and also may include a non-volatile memory, such as at least one disk storage device, flash storage device, or other non-volatile solid-state storage devices. In some embodiments, the memory 520 optionally includes memories remotely disposed with respect to the processor 510, and the remote memories may be connected, via a network, to the apparatus for adjusting video progress. Examples of the foregoing network include but are not limited to: the Internet, an intranet, a local area network, a mobile communications network, and a combination thereof.

The input apparatus 530 can receive entered digit or character information, and generate key signal inputs relevant to user setting and functional control of the apparatus for adjusting video progress. The output apparatus 540 may include a display device, for example, a display screen, etc.

The one or more modules are stored in the memory 520, and execute the method for adjusting video progress in any one of the foregoing method embodiments when being executed by the one or more processors 510.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A method for adjusting video progress, applied to a terminal, wherein a video play window comprises a progress bar, and the method comprises:
acquiring a progress adjusting operation above the progress bar, wherein in the video play window, the progress adjusting operation corresponds to a start contact;
using any two points on the progress bar as endpoints, and displaying a trajectory according to the endpoints and the start contact;
acquiring, in the video play window, a slide operation corresponding to the progress adjusting operation, wherein the trajectory changes with the slide operation;
acquiring, in the video play window, a release operation corresponding to the progress adjusting operation, wherein in the video play window, the release operation corresponds to an end contact; and
adjusting video play progress according a distance between a point that is a mapping point of the end contact and is on the progress bar and a current play progress point.

2. The method according to claim 1, wherein the acquiring a progress adjusting operation above the progress bar comprises:
acquiring, in the video play window, a press operation of a user;
parsing force of the press operation; and
determining whether the press operation is the progress adjusting operation according to the force of the press operation.

3. The method according to claim 2, wherein the press operation is light tap, light press, or heavy press.

4. The method according to claim 1, wherein the trajectory is a smooth curve or a broken line.

5. The method according to claim 4, wherein the smooth curve is a parabola or an arc.

6. The method according to claim 1, wherein the start contact and/or the end contact are/is between the endpoints, or, the start contact and/or the end contact are/is one of the endpoints; or the start contact and/or the end contact are/is before or after the current play progress point.

7-10. (canceled)

11. A non-volatile computer storage medium, which stores computer executable instructions, that when executed by an electronic device, cause the electronic device to:
acquire a progress adjusting operation above the progress bar, wherein in the video play window, the progress adjusting operation corresponds to a start contact;
use any two points on the progress bar as endpoints, and displaying a trajectory according to the endpoints and the start contact;
acquire, in the video play window, a slide operation corresponding to the progress adjusting operation, wherein the trajectory changes with the slide operation;
acquire, in the video play window, a release operation corresponding to the progress adjusting operation, wherein in the video play window, the release operation corresponds to an end contact; and
adjust video play progress according a distance between a point that is a mapping point of the end contact and is on the progress bar and a current play progress point.

12. The non-volatile computer storage medium according to claim 11, wherein to acquire a progress adjusting operation above the progress bar cause the electronic device to:
acquire, in the video play window, a press operation of a user;
parse force of the press operation; and
determine whether the press operation is the progress adjusting operation according to the force of the press operation.

13. The non-volatile computer storage medium according to claim 12, wherein the press operation is light tap, light press, or heavy press.

14. The non-volatile computer storage medium according to claim 11, wherein the trajectory is a smooth curve or a broken line.

15. The non-volatile computer storage medium according to claim 14, wherein the smooth curve is a parabola or an arc.

16. The non-volatile computer storage medium according to claim 11, wherein the start contact and/or the end contact are/is between the endpoints, or, the start contact and/or the end contact are/is one of the endpoints; or the start contact and/or the end contact are/is before or after the current play progress point.

17. An electronic device, comprising:
at least one processor; and
a memory in communication connection with the at least one processor, where the memory stores instructions that can be executed by the at least one processor, and wherein execution of the instructions by the at least one processor causes the at least one processor to:
acquire a progress adjusting operation above the progress bar, wherein in the video play window, the progress adjusting operation corresponds to a start contact;
use any two points on the progress bar as endpoints, and displaying a trajectory according to the endpoints and the start contact;
acquire, in the video play window, a slide operation corresponding to the progress adjusting operation, wherein the trajectory changes with the slide operation;
acquire, in the video play window, a release operation corresponding to the progress adjusting operation, wherein in the video play window, the release operation corresponds to an end contact; and
adjust video play progress according a distance between a point that is a mapping point of the end contact and is on the progress bar and a current play progress point.

18. The electronic device according to claim 17, wherein to acquire a progress adjusting operation above the progress bar the at least one processor is caused to:
acquire, in the video play window, a press operation of a user;
parse force of the press operation; and
determine whether the press operation is the progress adjusting operation according to the force of the press operation.

19. The electronic device according to claim 18, wherein the press operation is light tap, light press, or heavy press.

20. The electronic device according to claim 17, wherein the trajectory is a smooth curve or a broken line.

21. The electronic device according to claim 20, wherein the smooth curve is a parabola or an arc.

22. The electronic device according to claim 17, wherein the start contact and/or the end contact are/is between the endpoints, or, the start contact and/or the end contact are/is one of the endpoints; or the start contact and/or the end contact are/is before or after the current play progress point.
